(19) United States
(12) Patent Application Publication
(10) Pub. No.: US 2017/0237454 A1
(43) Pub. Date: Aug. 17, 2017

(54) NON-LINEAR PRODUCT DETECTION AND CANCELLATION IN A WIRELESS DEVICE

(71) Applicant: QUALCOMM Incorporated, San Diego, CA (US)

(72) Inventor: Haim Mendel Weissman, Haifa (IL)

(21) Appl. No.: 15/149,771

(22) Filed: May 9, 2016

Related U.S. Application Data
(60) Provisional application No. 62/294,697, filed on Feb. 12, 2016.

(51) Int. Cl. H04B 1/04

(52) U.S. Cl. CPC H04B 1/0475; H04B 2001/0408

(57) ABSTRACT

An apparatus and method for cancelling and/or attenuating one or more signal impairments included within a transmitted RF signal is disclosed. In at least one exemplary embodiment, a baseband signal is generated based, at least in part, on a predicted impairment signal subtracted from a desired baseband signal. An impairment detection signal may be generated by multiplying the predicted impairment signal by the baseband signal. The predicted impairment signal may be adjusted based, at least in part, on the impairment detection signal.

### CROSS-REFERENCE TO RELATED APPLICATION

This application claims priority to U.S. Provisional Patent Application No. 62/294,697 entitled “NON-LINEAR PRODUCT DETECTION AND CANCELLATION IN A WIRELESS DEVICE” filed Feb. 12, 2016, the entirety of which is incorporated by reference herein.

### TECHNICAL FIELD

The exemplary embodiments relate generally to wireless devices, and specifically to detecting and reducing and/or cancelling non-linear product signal impairments included within transmitted signals.

### BACKGROUND OF RELATED ART

A wireless device (e.g., a cellular phone or a smartphone) in a wireless communication system may transmit and receive data for two-way communications. The wireless device may include a transmitter for data transmission and a receiver for data reception. During data transmission, the transmitter may modulate a radio frequency (RF) carrier signal with data to generate a modulated RF signal. The transmitter may amplify the modulated RF signal to an output power level and transmit the RF signal via one or more antennas to another device such as, for example, a base station. During data reception, the receiver may receive an RF signal from another device via one or more antennas. The receiver may amplify and process the received RF signal to recover data sent by the other device.

A transmitted RF signal may include a number of undesired impairments. Such impairments may include non-linear products such as, for example, 4FMOD (e.g., a third and/or fifth harmonic of a modulating signal), a residual side band (RSB) signal, or an intermodulation distortion. These undesired impairments may interfere with other communication systems. Therefore, regulatory agencies may require wireless devices to limit the generation and/or radiation of certain impairments (e.g., non-linear products).

Thus, there is a need to reduce or limit undesired impairments when transmitting RF signals.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

In some aspects, a wireless device is disclosed. The wireless device may include a first circuit to generate a baseband signal, a second circuit to generate a first impairment signal associated with the baseband signal, and a detector circuit to generate an impairment detection signal based, at least in part, on the first impairment signal and a first signal formed by combining the first impairment signal and the baseband signal.

In other aspects, a method of transmitting a wireless communication signal by a wireless device is disclosed. A baseband processor of the wireless device may generate a baseband signal and a first impairment generator may generate a first impairment signal. An impairment detection signal may be generated based, at least in part, on the first impairment signal and a first signal formed by combining the first impairment signal and the baseband signal.

In another aspect, an impairment detector is disclosed. The impairment detector may include a first selector to receive a first modified baseband signal, a second selector to receive a first impairment signal, and a mixer to generate a detection signal based, at least in part, on the first impairment signal and the first modified baseband signal.

### BRIEF DESCRIPTION OF THE DRAWINGS

The exemplary embodiments are illustrated by way of example and are not intended to be limited by the figures of the accompanying drawings. Like numbers reference like elements throughout the drawings and specification.

FIG. 1 shows a wireless device communicating with a wireless communication system, in accordance with some exemplary embodiments.

FIG. 2 shows an exemplary design of the wireless device of FIG. 1.

FIG. 3 is a block diagram of a transmitter, in accordance with some exemplary embodiments.

FIG. 4 is a block diagram showing more detailed embodiments of the digital processing module and the analog processing module of FIG. 3.

FIG. 5 is a block diagram of an exemplary embodiment of a baseband signal generator.

FIG. 6 is a block diagram showing a more detailed embodiment of the analog processing module of FIG. 3.

FIG. 7 is a simplified circuit diagram of an exemplary embodiment of the canceller of FIG. 6.

FIG. 8 is a block diagram a transmitter, in accordance with some exemplary embodiments.

FIG. 9 is a simplified circuit diagram of a feedback receiver, in accordance with some exemplary embodiments.

FIG. 10 is a simplified block diagram of an impairment detector, in accordance with some exemplary embodiments.

FIG. 11 shows a wireless device which may be one embodiment of the wireless device of FIG. 1.

FIG. 12 shows an illustrative flow chart depicting an example operation for generating a predicted impairment signal in accordance with example embodiments.

### DETAILED DESCRIPTION

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature and/or details are set forth to provide a thorough understanding of the exemplary embodiments. However, it will be apparent to one skilled in the art that these specific details may not be required to practice the exemplary embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The exemplary embodiments are not to be construed as limited to specific examples described herein but rather to include within their scope all exemplary embodiments defined by the appended claims.

In addition, the detailed description set forth below in connection with the appended drawings is intended as a description of exemplary embodiments of the present disclosure and is not intended to represent the only exemplary embodiments in which the present disclosure may be practiced. The term “exemplary” used throughout this description means “serving as an example, instance, or illustration,” and should not necessarily be construed as preferred or advantageous over other exemplary embodiments.

Further, combinations such as “at least one of A, B, or C,” “at least one of A, B, and C,” and “at least A or B or C or a combination thereof” include any combination of A, B, and/or C, and may include multiples of A, multiples of B, or multiples of C. Specifically, combinations such as “at least A or B or C or a combination thereof,” “at least one of A, B, or C,” “at least one of A, B, and C,” “and “A, B, C, or any combination thereof” may be A only, B only, C only, A and B, A and C, B and C, or A and B and C, where any such combinations may contain one or more member or members of A, B, or C.

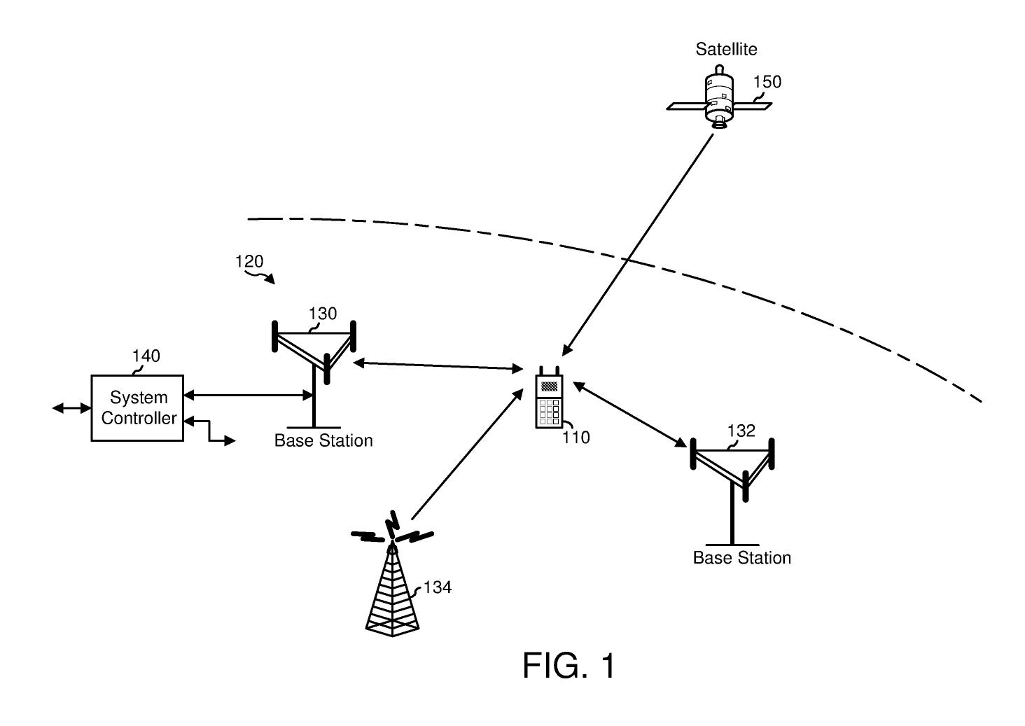

FIG. 1 shows a wireless device 110 communicating with a wireless communication system 120, in accordance with some exemplary embodiments. Wireless communication system 120 may be a 3rd Generation Partnership Program (3GPP) Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1×, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless system may include any number of base stations and any set of network entities.

Wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may communicate with wireless communication system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1×, EVDO, TD-SCDMA, GSM, 802.11, etc.

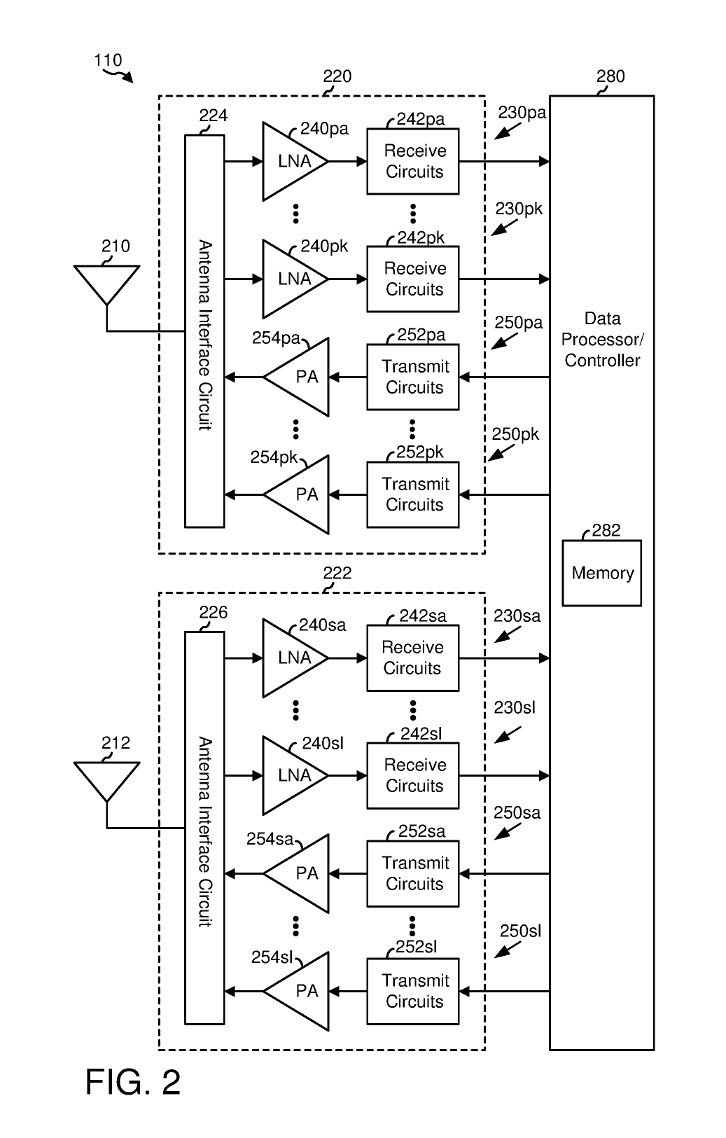

FIG. 2 shows a block diagram of an exemplary design of the wireless device 110 in FIG. 1. In this exemplary design, the wireless device 110 includes a primary transceiver 220 coupled to a primary antenna 210, a secondary transceiver 222 coupled to a secondary antenna 212, and a data processor/controller 280. Primary transceiver 220 includes a number (K) of receivers 230pa to 230pk and a number (K) of transmitters 250pa to 250pk to support multiple frequency bands, multiple radio technologies, carrier aggregation, etc. Secondary transceiver 222 includes a number (L) of receivers 230sa to 230sl and a number (L) of transmitters 250sa to 250sl to support multiple frequency bands, multiple radio technologies, carrier aggregation, receive diversity, multiple-input multiple-output (MIMO) transmission from multiple transmit antennas to multiple receive antennas, etc.

In the exemplary design shown in FIG. 2, each receiver 230 includes a low noise amplifier (LNA) 240 and receive circuits 242. For data reception, primary antenna 210 receives signals from base stations and/or other transmitter stations and provides a received radio frequency (RF) signal, which is routed through an antenna interface circuit 224 and presented as an input RF signal to a selected receiver. Antenna interface circuit 224 may include switches, duplexers, transmit filters, receive filters, matching circuits, etc. The description below assumes that receiver 230pa is the selected receiver. Within receiver 230pa, an LNA 240pa amplifies the input RF signal and provides an output RF signal. Receive circuits 242pa downconvert the output RF signal from RF to baseband, amplify and filter the downconverted signal, and provide an analog input signal to data processor/controller 280. Receive circuits 242pa may include mixers, filters, amplifiers, matching circuits, an oscillator, a local oscillator (LO) generator, a phase locked loop (PLL), etc. Each remaining receiver 230 in transceivers 220 and 222 may operate in similar manner as receiver 230pa.

In the exemplary design shown in FIG. 2, each transmitter 250 includes transmit circuits 252 and a power amplifier (PA) 254. For data transmission, data processor/controller 280 processes (e.g., encodes and modulates) data to be transmitted and provides an analog output signal to a selected transmitter. The description below assumes that transmitter 250pa is the selected transmitter. Within transmitter 250pa, transmit circuits 252pa amplify, filter, and upconvert the analog output signal from baseband to RF and provide a modulated RF signal. Transmit circuits 252pa may include amplifiers, filters, mixers, matching circuits, an oscillator, an LO generator, a PLL, etc. A PA 254pa receives and amplifies the modulated RF signal and provides a transmit RF signal having the proper output power level. The transmit RF signal is routed through antenna interface circuit 224 and transmitted via primary antenna 210. Each remaining transmitter 250 in transceivers 220 and 222 may operate in similar manner as transmitter 250pa.

Each receiver 230 and transmitter 250 may also include other circuits not shown in FIG. 2, such as filters, matching circuits, etc. All or a portion of transceivers 220 and 222 may be implemented on one or more analog integrated circuits (ICs), RF ICs (RFICs), mixed-signal ICs, etc. For example, LNAs 240 and receive circuits 242 within transceivers 220 and 222 may be implemented on multiple IC chips, as described below. The circuits in transceivers 220 and 222 may also be implemented in other manners.

Data processor/controller 280 may perform various functions for wireless device 110. For example, data processor/controller 280 may perform processing for data being received via receivers 230 and data being transmitted via transmitters 250. Data processor/controller 280 may control the operation of the various circuits within transceivers 220 and 222. A memory 282 may store program codes and data for data processor/controller 280. Data processor/controller 280 may be implemented on one or more application specific integrated circuits (ASICs) and/or other ICs.

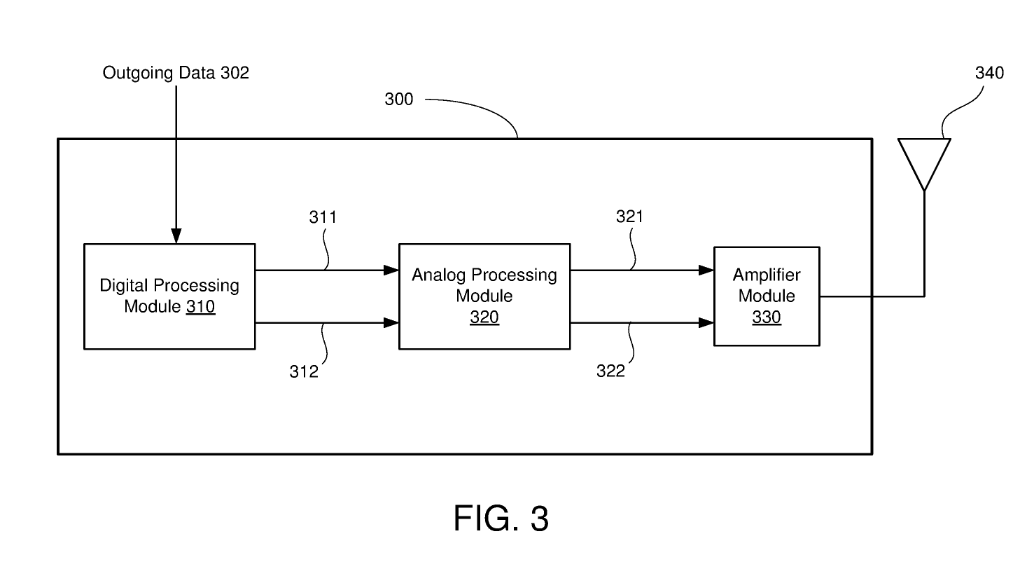

FIG. 3 is a block diagram of a transmitter 300, in accordance with some exemplary embodiments. Transmitter 300 may be an embodiment of transmitters 250pa-250pk and/or transmitters 250sa-250sl shown in FIG. 2. Transmitter 300 may include a digital processing module 310, an analog processing module 320, an amplifier module 330, and an antenna 340.

Digital processing module 310 may receive outgoing data 302 from a processor or controller of a wireless device (e.g., data processor/controller 280 of FIG. 2). In some embodiments, digital processing module 310 may generate quadrature baseband signals (e.g., in-phase (I) and quadrature (Q) signals) based, at least in part, on the outgoing data 302. For example, digital processing module 310 may generate a digital in-phase signal 311 and a digital quadrature signal 312.

Analog processing module 320 may convert the digital baseband signals (e.g., digital in-phase signal 311 and/or digital quadrature signal 312) into analog baseband signals (e.g., analog in-phase signal 321 and/or analog quadrature signal 322, respectively). More specifically, the digital in-phase signal 311 may be converted to a corresponding analog in-phase signal 321 and the digital quadrature signal 312 may be converted to a corresponding analog quadrature signal 322. In some embodiments, the analog processing module 320 may provide analog signal processing for the analog baseband signals 321 and 322. For example, the analog processing module 320 may include filters, amplifiers, and/or mixers (not shown for simplicity) to generate the analog baseband signals 321 and 322.

The amplifier module 330 may prepare the analog baseband signals 321 and 322 to be transmitted via the antenna 340. In some embodiments, the amplifier module 330 may include one or more mixers to upconvert the analog baseband signals 321 and 322 to a carrier frequency, and generate a modulated RF signal based on the analog baseband signals 321 and 322. Further, the amplifier module 330 may include one or more driver amplifiers and/or power amplifiers (not shown for simplicity) to amplify the modulated RF signal to a desired power level for transmission over a wireless medium. The antenna 340 may be an embodiment of primary antenna 210 and/or secondary antenna 212 of FIG. 2.

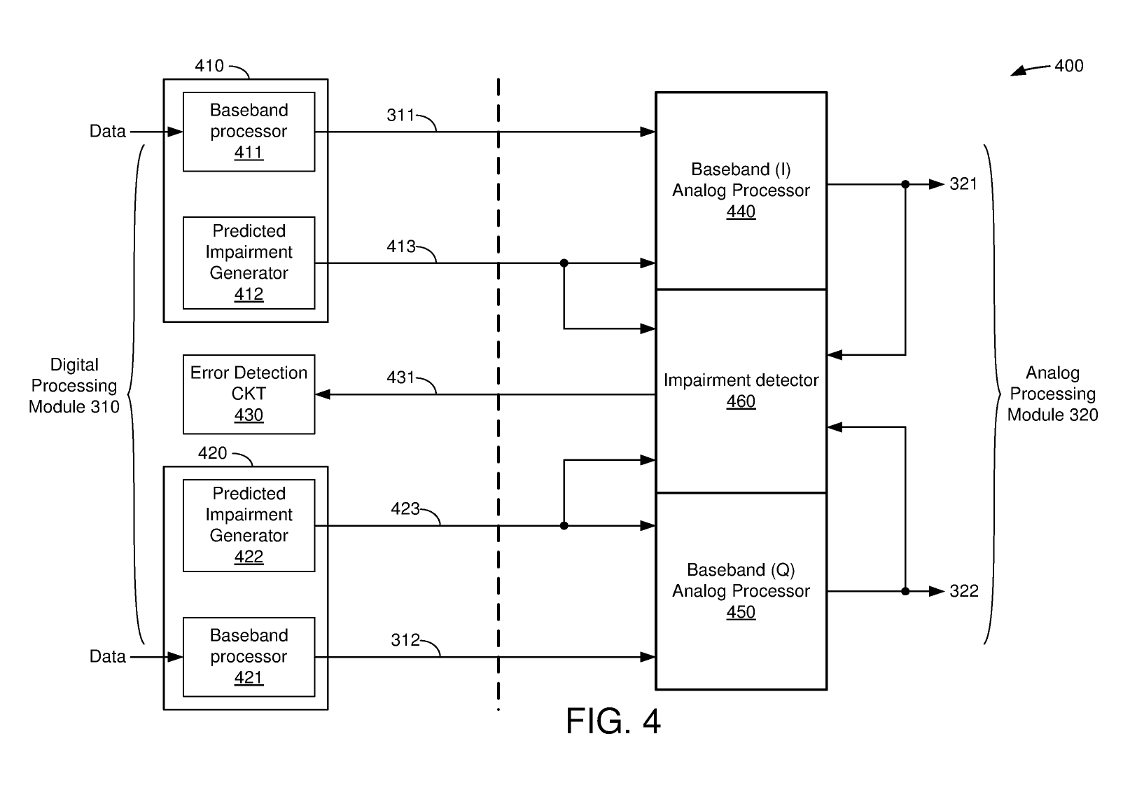

FIG. 4 is a block diagram 400 showing more detailed embodiments of the digital processing module 310 and the analog processing module 320 of FIG. 3. The digital processing module 310 may include a baseband (I) generator 410, a baseband (Q) generator 420, and an error detection circuit 430. The analog processing module 320 may include a baseband (I) analog processor 440, a baseband (Q) analog processor 450, and an impairment detector 460.

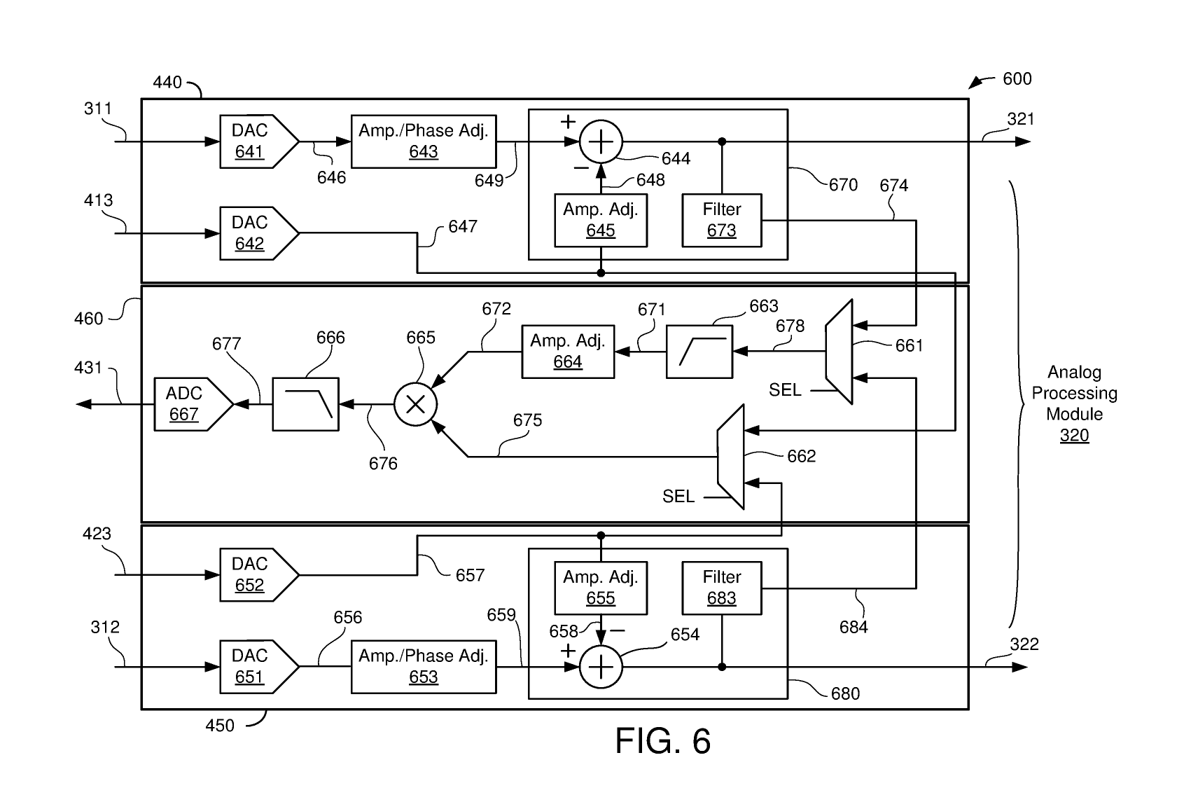

The baseband (I) generator 410 may include a first baseband processor 411 and a first predicted impairment generator 412. The first baseband processor 411 may generate the digital in-phase signal 311 based, at least in part, on the outgoing data 302 (e.g., as described above with respect to FIG. 3). The first predicted impairment generator 412 may generate (e.g., synthesize) a digital predicted impairment (I) signal 413 that may be used to cancel or attenuate undesired signal impairments, such as non-linear products, that may be included and/or introduced with the analog in-phase signal 321. For example, one or more signal impairments may be unintentionally included with the analog in-phase signal 321. The first predicted impairment generator 412 may generate the digital predicted impairment (I) signal 413 to anticipate one or more of the included signal impairments. Persons skilled in the art will appreciate that the first baseband processor 411 and the first predicted impairment generator 412 may each include one or more circuits and/or components to generate the digital in-phase signal 311 and the digital predicted impairment (I) signal 413, respectively (circuits/components not shown for simplicity). For example, the first baseband processor 411 and/or the first predicted impairment generator 412 may include one or more transistors, capacitors, resistors, inductors, gates, or other components arranged to generate the digital in-phase signal 311 and the digital predicted impairment (I) signal 413, respectively. Processing of the digital in-phase signal 311 to cancel or attenuate a signal impairment is described in more detail below in conjunction with FIG. 6.

Although only the first predicted impairment generator 412 is shown (for simplicity), in some embodiments, the baseband (I) generator 410 may include any number of predicted impairment generators (e.g., similar to the first predicted impairment generator 412) to generate any number of digital predicted impairment (I) signals. Additionally, although the first predicted impairment generator 412 is depicted as separate from the first baseband processor 411, in some embodiments the first predicted impairment generator 412 may be included within, or be a part of the first baseband processor 411.

The baseband (Q) generator 420 may include a second baseband processor 421 to generate the digital quadrature signal 312 based on the outgoing data 302 (e.g., as described above with respect to FIG. 3). The baseband (Q) generator 420 may further include a second predicted impairment generator 422 to generate a digital predicted impairment (Q) signal 423 that may be used to cancel or attenuate undesired signal impairments, such as non-linear products, that may be included and/or introduced with the analog quadrature signal 322. Persons skilled in the art will appreciate that the second baseband processor 421 and the second predicted impairment generator 422 may each include one or more circuits and/or components to generate the digital quadrature signal 312 and the digital predicted impairment (Q) signal 423, respectively (circuits/components not shown for simplicity). For example, the second baseband processor 421 and/or the second predicted impairment generator 422 may include one or more transistors, capacitors, resistors, inductors, gates, or other components arranged to generate the digital quadrature signal 312 and the digital predicted impairment (Q) signal 423, respectively. Processing of the digital quadrature signal 312 to cancel or attenuate a signal impairment is described in more detail below in conjunction with FIG. 6. In some embodiments, the baseband (Q) generator 420 may include any number of predicted impairment generators (e.g., similar to the second predicted impairment generator 422) to generate any number of digital predicted impairment (Q) signals. Additionally, although the second predicted impairment generator 422 is depicted as separate from the second baseband processor 421, in some embodiments the second predicted impairment generator 422 may be included within, or be a part of the second baseband processor 421.

The baseband (I) analog processor 440 may generate the analog in-phase signal 321 based, at least in part, on the digital in-phase signal 311 and the corresponding digital predicted impairment (I) signal 413. In at least one embodiment, an analog version of the digital predicted impairment (I) signal 413 may be subtracted from an analog version the digital in-phase signal 311 to generate the analog in-phase signal 321. Similarly in at least one embodiment, baseband (Q) analog processor 450 may generate the analog quadrature signal 322 by subtracting an analog version the digital predicted impairment (Q) signal 423 from an analog version of the digital quadrature signal 312. Generation of the analog in-phase signal 321 and the analog quadrature signal 322 are described in more detail below in conjunction with FIG. 6.

The impairment detector 460 receives the digital predicted impairment (I) signal 413, the digital predicted impairment (Q) signal 423, the analog in-phase signal 321, and the analog quadrature signal 322. For some embodiments, the impairment detector 460 may detect signal impairments that may be included with the analog in-phase signal 321 and/or analog quadrature signal 322. Note that the analog in-phase signal 321 may be generated by subtracting the analog version of the digital predicted impairment (I) signal 413 from the analog version of the digital in-phase signal 311 and the analog quadrature signal 322 may be generated by subtracting the analog version of the digital predicted impairment (Q) signal 423 from the analog version of the digital quadrature signal 312. Thus, impairment detector 460 may detect residual signal impairments remaining with analog in-phase signal 321 and/or analog quadrature signal 322. Some signal impairments may include, for example, a 4FMOD signal, a residual side band (RSB) signal, an intermodulation distortion signal, or any other technically feasible undesired signal. The 4FMOD signal may be due to an upconverted third harmonic of a baseband signal mixed with an LO signal. The RSB signal may be a result of an I/O imbalance within the transmitter 300. For example, if the in-phase LO signal does not completely cancel the quadrature LO signal during modulation, then some residual carrier signal (e.g., the RSB signal) may be present in the transmitted signal.

The impairment detector 460 may generate an impairment detection signal 431 that may be proportional to the amount of signal impairment included with at least one of the analog baseband signals 321 and/or 322. For some embodiments, the signal impairment may be detected based, at least in part, on the digital predicted impairment (I) signal 413 and/or the digital predicted impairment (Q) signal 423. For example, the impairment detection signal 431 may indicate a presence and/or magnitude of the digital predicted impairment (I) signal 413 as it relates to the digital in-phase signal 311. The impairment detection signal 431 may additionally, or alternatively, indicate a presence and/or magnitude of the digital predicted impairment (Q) signal 423 as it relates to the digital quadrature signal 312. Persons skilled in the art will appreciate that the impairment detector 460 may include one or more circuits and/or components to generate the impairment detection signal 431 (circuits/components not shown for simplicity). For example, the impairment detector 460 may include one or more transistors, capacitors, resistors, inductors, gates, and/or other components arranged to generate the impairment detection signal 431. Operation of the impairment detector 460 is described in more detail below in conjunction with FIG. 6.

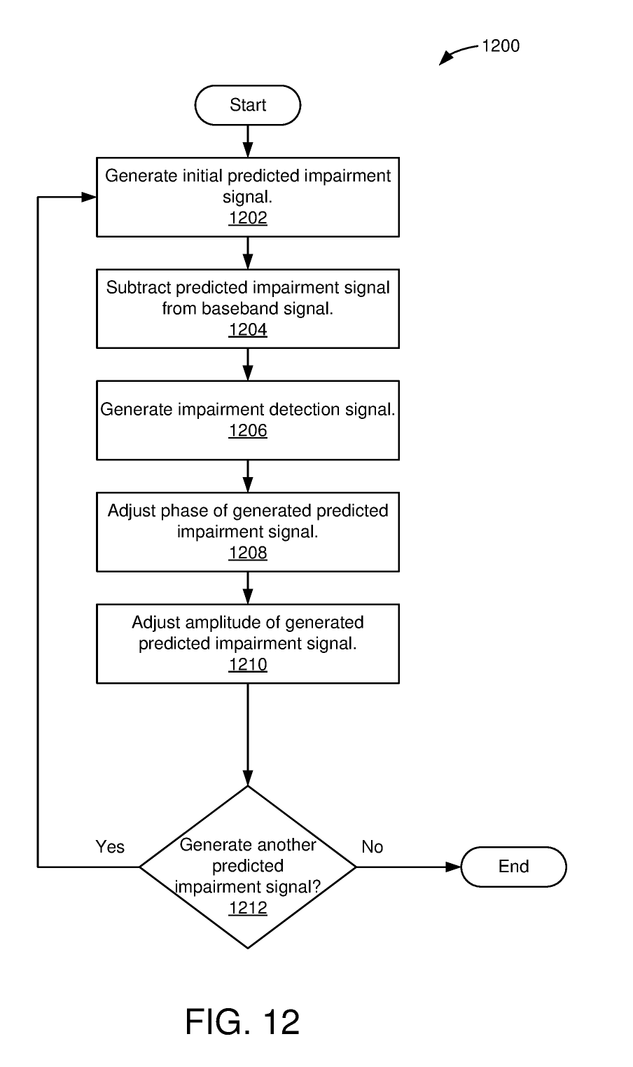

The error detection circuit 430 may receive the impairment detection signal 431 from the impairment detector 460. As described above, the impairment detection signal 431 may vary proportionally to a magnitude of a signal impairments detected by the impairment detector 460. For some embodiments, the error detection circuit 430 may monitor and/or analyze the impairment detection signal 431 to fine tune operations of the first predicted impairment generator 412 and/or the second predicted impairment generator 422. An operation of the error detection circuit 430 is described in greater detail below with respect to FIG. 12.

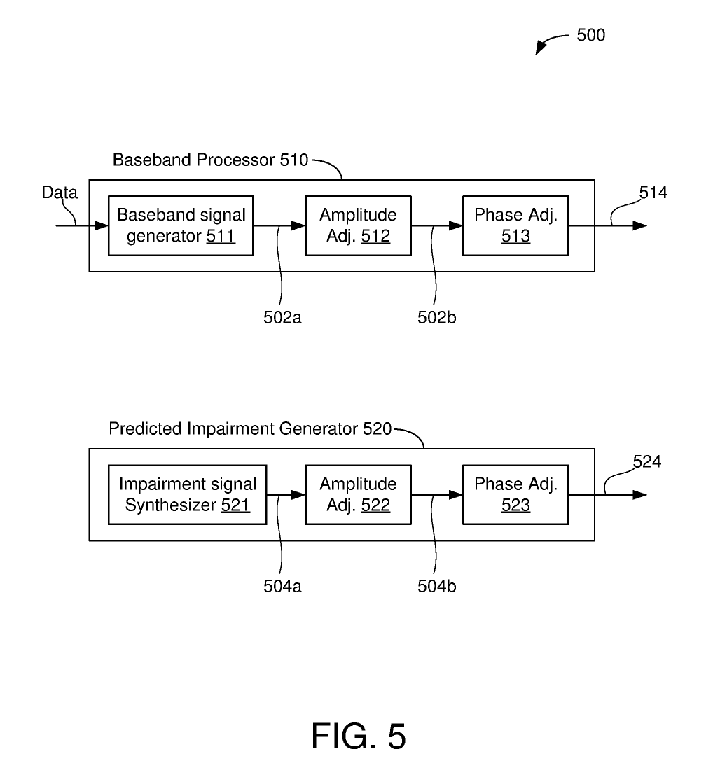

FIG. 5 is a block diagram of an exemplary embodiment of a baseband signal generator 500. The baseband signal generator 500 may be an example embodiment of the baseband (I) generator 410 and/or the baseband (Q) generator 420 shown in FIG. 4. The baseband signal generator 500 may include a baseband processor 510 and a predicted impairment generator 520. The baseband processor 510 may be an example embodiment of the first baseband processor 411 and/or the second baseband processor 421, and the predicted impairment generator 520 may be an example embodiment of the first predicted impairment generator 412 and/or the second predicted impairment generator 422.

Baseband processor 510 may include a baseband signal generator 511, a baseband amplitude adjustment module 512, and a baseband phase adjustment module 513. The baseband signal generator 511 may receive data (e.g., outgoing data 302) to be encoded into a digital baseband signal. The baseband signal generator 511 may generate an initial baseband signal 502a based, at least in part, on the received data. An amplitude of the initial baseband signal 502a may be adjusted by the baseband amplitude adjustment module 512. An intermediate baseband signal 502b may be generated by the baseband amplitude adjustment module 512. A phase of the intermediate baseband signal 502b may be adjusted by the baseband phase adjustment module 513. The resulting signal, output by the baseband processor 510, may be a digital baseband signal 514. For example, the digital baseband signal 514 may correspond to the digital in-phase signal 311 or the digital quadrature signal 312.

Predicted impairment generator 520 may include an impairment signal synthesizer 521, an impairment amplitude adjustment module 522, and an impairment phase adjustment module 523. The impairment signal synthesizer 521 may generate a digital signal representation of a digital predicted impairment signal 524. The digital predicted impairment signal 524 may be a harmonic of a modulating signal, a residual side band signal, an intermodulation distortion signal, or any other technically feasible signal.

The impairment signal synthesizer 521 may generate an initial impairment signal 504a based, at least in part, on impairment signal characteristics that may be stored in a memory. In some embodiments, bench testing and/or simulation may determine the impairment signal characteristics. For example, bench testing transmitter 300 may identify one or more impairment signals (e.g., 4FMOD, RSB, and/or intermodulation distortion signals). The identified impairment signals may be analyzed and one or more signal characteristics of the impairment signals, including for example, frequency, amplitude, and/or phase attributes, may be determined. The signal characteristics of the identified impairment signals may be stored in memory or tables. Thus, the stored signal characteristics may be used to synthesize the initial impairment signal 504a to be similar to the previously identified impairment signal. In a similar manner, computer simulation of transmitter 300 may determine and/or identify impairment signals.

An amplitude of the initial impairment signal 504a may be adjusted by the impairment amplitude adjustment module 522. An intermediate impairment signal 504b may be generated by the impairment amplitude adjustment module 522. The phase of the intermediate impairment signal 504b may be adjusted by the impairment phase adjustment module 523. In some embodiments, the impairment amplitude adjustment module 522 may have an output range (e.g., gain range) of approximately 2 dB and an accuracy of 0.1 dB. In some embodiments, the amplitude and phase signal characteristics stored in memory and/or tables may determine, at least in part, settings used by the impairment amplitude adjustment module 522 and/or the impairment phase adjustment module 523. The resulting signal, output by the predicted impairment generator 520, may correspond to the digital predicted impairment signal 524. For example, the digital predicted impairment signal 524 may correspond to the digital predicted impairment (I) signal 413 or the digital predicted impairment (Q) signal 423.

FIG. 6 is a block diagram 600 showing a more detailed embodiment of the analog processing module 320 of FIG. 3. As described above with respect to FIG. 4, the analog processing module 320 includes baseband (I) analog processor 440, baseband (Q) analog processor 450, and impairment detector 460.

Baseband (I) analog processor 440 may include a first digital-to-analog converter (DAC) 641, a second DAC 642, a first analog amplitude/phase adjustment module 643, and a first canceller 670. The first DAC 641 receives the digital in-phase signal 311 from the baseband (I) generator 410, and generates a first analog signal 646 based on the digital in-phase signal 311. The first analog amplitude/phase adjustment module 643 may adjust the phase and/or amplitude of the first analog signal 646 to produce a first intermediate analog signal 649. In some embodiments, the first analog amplitude/phase adjustment module 643 may include amplifiers, phase rotators, etc. to generate the first intermediate analog signal 649. Thus, the first intermediate analog signal 649 may be an adjusted analog version of the digital in-phase signal 311.

The second DAC 642 receives the digital predicted impairment (I) signal 413 from the baseband (I) generator 410, and generates an analog predicted in-phase impairment signal 647. In some embodiments, the second DAC 642 may be a DAC with a limited dynamic range. For example, the dynamic range (e.g., resolution) of the second DAC 642 may be based, at least in part, on a desired dynamic range of the analog predicted in-phase impairment signal 647. If the desired dynamic range is 20 dB and the dynamic range of the second DAC 642 is six times the number of bits of the DAC (e.g., 6×#bits), then the resolution of the second DAC 642 may be 4 bits.

The analog predicted in-phase impairment signal 647 and the first intermediate analog signal 649 may be provided to the first canceller 670. The first canceller 670 may include a first adder 644, a first analog amplitude adjustment module 645, and a first filter 673. The first analog amplitude adjustment module 645 may generate an adjusted analog predicted impairment (I) signal 648 based on the analog predicted in-phase impairment signal 647. In some embodiments, the first analog amplitude adjustment module 645 may have more than 20 dB of amplitude output range (e.g., gain range) and may have an associated gain accuracy of 1 dB.

The first adder 644 may generate the analog in-phase signal 321 based on the first intermediate analog signal 649 and the adjusted analog predicted impairment (I) signal 648. For example, the first adder 644 may subtract the adjusted analog predicted impairment (I) signal 648 from the first intermediate analog signal 649 to generate the analog in-phase signal 321. Subtracting the adjusted analog predicted impairment (I) signal 648 (e.g., an adjusted version of the predicted impairment (I) signal) from the first intermediate analog signal 649 may cancel or attenuate impairments, such as non-linear impairments, modeled by the first predicted impairment generator 412. In other words, the first adder 644 may generate a modified baseband signal (e.g., the analog in-phase signal 321) by subtracting an impairment signal (e.g., a signal associated with the digital predicted impairment (I) signal 413) from an unmodified baseband signal (e.g., a signal associated with the digital in-phase signal 311). As described above with respect to FIG. 5, the phase of the digital predicted impairment signal 524 may be controlled through the predicted impairment generator 520 (e.g., phase of the analog predicted in-phase impairment signal 647 may be controlled through the first predicted impairment generator 412). Controlling the phase of the analog predicted in-phase impairment signal 647 (e.g., through impairment phase adjustment module 523) may be performed as an alternative, or in addition to adjusting the phase of the first analog signal 646 through the first analog amplitude/phase adjustment module 643 to cancel and/or attenuate an impairment signal. The analog in-phase signal 321 may be filtered by the first filter 673 and provided to the impairment detector 460 through a first filtered baseband signal 674.

In other embodiments, the digital predicted impairment (I) signal 413 may be subtracted from the digital in-phase signal 311 in the digital domain rather than in the analog domain (not shown for simplicity). For example the first analog amplitude/phase adjustment module 643, the first adder 644, the first analog amplitude adjustment module 645, and the first filter 673 may be implemented digitally, instead of through the analog implementations described herein. The output of the first adder 644 may then be converted to an analog signal by a DAC (not shown for simplicity).

Baseband (Q) analog processor 450 may be similar to baseband (I) analog processor 440. For example, the baseband (Q) analog processor 450 may include a third DAC 651, a fourth DAC 652, a second analog amplitude/phase adjustment module 653, and a second canceller 680.

The third DAC 651 receives the digital quadrature signal 312 from the baseband (Q) generator 420, and generates a second analog signal 656. The second analog amplitude/phase adjustment module 653 may adjust a phase and/or amplitude of the second analog signal 656 to produce a second intermediate analog signal 659. Thus, the second intermediate analog signal 659 may be an adjusted analog version of digital quadrature signal 312. The fourth DAC 652 receives the digital predicted impairment (Q) signal 423 from the baseband (Q) generator 420 and generates an analog predicted quadrature impairment signal 657.

The analog predicted quadrature impairment signal 657 and the second intermediate analog signal 659 may be provided to the second canceller 680. The second canceller 680 may include a second adder 654, a second analog amplitude adjustment module 655, and a second filter 683. The second analog amplitude adjustment module 655 may generate an adjusted analog predicted impairment (Q) signal 658 based on the analog predicted quadrature impairment signal 657.

The second adder 654 may generate the analog quadrature signal 322 based on the second intermediate analog signal 659 and the adjusted analog predicted impairment (Q) signal 658. For example, the second adder 654 may subtract the adjusted analog predicted impairment (Q) signal 658 from the second intermediate analog signal 659 to generate the analog quadrature signal 322. In other words, the second adder 654 may generate a modified baseband signal (e.g., the analog quadrature signal 322) by subtracting an impairment signal (e.g., a signal associated with the digital predicted impairment (Q) signal 423) from an unmodified baseband signal (e.g., a signal associated with the digital quadrature signal 312). The analog quadrature signal 322 may be filtered by the second filter 683 and provided to the impairment detector 460 through a second filtered baseband signal 684. As described above with respect to FIG. 5, the phase of the digital predicted impairment signal 534 may be controlled through the second predicted impairment generator 520 (e.g., phase of the analog predicted quadrature impairment signal 657 may be controlled through the second predicted impairment generator 422). Controlling the phase of the analog predicted quadrature impairment signal 657 may be performed as an alternative, or in addition to adjusting the phase of the second analog signal 656 through the second analog amplitude/phase adjustment module 653 to cancel and/or attenuate an impairment signal.

In other embodiments, the digital predicted impairment (Q) signal 423 may be subtracted from the digital quadrature signal 312 in the digital domain rather than in the analog domain (not shown for simplicity). For example the second analog amplitude/phase adjustment module 653, the second adder 654, the second analog amplitude adjustment module 655, and the second filter 683 may be implemented digitally, instead of through the analog implementations described herein. The output of the second adder 654 may then be converted to an analog signal by a DAC (not shown for simplicity).

The impairment detector 460 may detect non-linear products and/or other impairments that may be included within a selected baseband signal. For example, the impairment detector 460 may generate the impairment detection signal 431 based on non-linear products or other impairments that are detected within the first filtered baseband signal 674 and/or the second filtered baseband signal 684. In some embodiments, the impairment detector 460 may detect impairments by multiplying a selected predicted impairment signal with a selected baseband signal. For example, the impairment detector 460 may include a mixer to multiply the selected predicted impairment signal with the selected baseband signal. Impairments within the selected baseband signal having similar signal characteristics to the predicted impairment signal may be mixed to a direct current (DC) or near DC signal. Thus, the DC and/or near DC content of the mixer output signal may be in direct proportion to the magnitude of the selected predicted impairment signal included within the selected baseband signal.

The impairment detector 460 may include a first selector 661, a second selector 662, a first filter 663, a third analog amplitude adjustment module 664, a mixer 665, a second filter 666, and an analog-to-digital converter (ADC) 667. The first selector 661 may receive and selectively output one of the first filtered baseband signal 674 and the second filtered baseband signal 684 as a selected signal 678. For some embodiments, the first selector 661 may select either the first filtered baseband signal 674 or the second filtered baseband signal 684 based on a select (SEL) signal. The first selector 661 may provide the selected signal 678 to the first filter 663. In some embodiments, the first filter 663 may be a high-pass filter to reject RF signals with frequencies near or below a critical (e.g., threshold) frequency and thereby pass RF signals that may be impairment signals with respect to desired RF signals. The first filter 663 may provide filtered signal 671 to the third analog amplitude adjustment module 664. The third analog amplitude adjustment module 664 may adjust an amplitude of the filtered signal 671 and provide an amplitude-adjusted baseband signal 672 to the mixer 665.

In a similar manner, the second selector 662 may receive the analog predicted in-phase impairment signal 647 (e.g., an analog version of the digital predicted impairment (I) signal 413) and the analog predicted quadrature impairment signal 657 (e.g., an analog version of the digital predicted impairment (Q) signal 423). The second selector 662 may select either the analog predicted in-phase impairment signal 647 or the analog predicted quadrature impairment signal 657 based on the SEL signal. The second selector 662 may couple the selected analog impairment signal 675 to mixer 665.

The mixer 665 may mix the amplitude-adjusted baseband signal 672 and the analog impairment signal 675 to generate a mixer output signal 676. As described above, the mixer output signal 676 may have a magnitude proportional to the magnitude of the analog impairment signal 675.

The mixer output signal 676 may be filtered by the second filter 666 to produce a filtered mixer output signal 677. In some embodiments, the second filter 666 may be a low-pass filter. The filtered mixer output signal 677 is provided to the ADC 667, which converts the filtered mixer output signal 677 to digital form (e.g., corresponding to the impairment detection signal 431).

The impairment detection signal 431 may indicate the presence of signal impairments within a selected baseband signal. Since a predicted impairment signal may have previously been subtracted from a corresponding selected baseband signal (as described above with respect to the first canceller 670 and the second canceller 680), the impairment detection signal 431 may indicate the presence of any residual impairment signal. A magnitude of the impairment detection signal 431 may be proportional to a magnitude of the signal impairment within the baseband signal. For example, the signal impairment may include any technically feasible signal that may be synthesized by the first predicted impairment generator 412 and/or the second predicted impairment generator 422. Accordingly, the impairment detector 460 may detect the presence of any technically feasible signal within the selected baseband signal. Those skilled in the art will appreciate that some signal impairments are more easily detectable in analog baseband signals than modulated RF analog signals. For example, harmonics of a modulating signal, residual side band signals, and/or intermodulation distortion may be more easily detected within analog baseband signals.

In some embodiments, the second filter 666 may block or filter relatively high frequencies (e.g., above a frequency threshold) so that the filtered mixer output signal 677 effectively becomes a DC signal or near DC signal. In some embodiments, the ADC 667 may be an ADC with a limited dynamic range. In other embodiments, the analog processing module 320 may include any number of impairment detectors. For example, each of the baseband analog processors 440 and 450 may be provided with its own impairment detector (e.g., rather than share the impairment detector 460). Thus, a first impairment detector (not shown) may be dedicated for use with in-phase (I) signals and a second impairment detector (not shown) may be dedicated for use with quadrature (Q) signals.

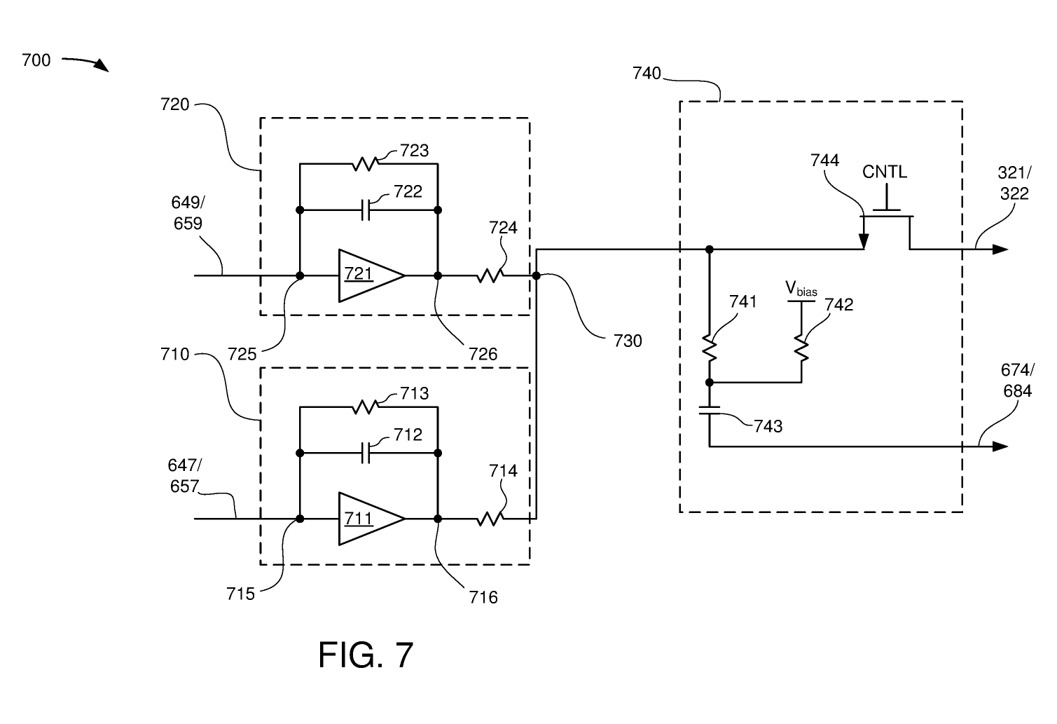

FIG. 7 is a simplified circuit diagram of an exemplary embodiment of a canceller 700. The canceller 700 may be an embodiment of the first canceller 670 and/or second canceller 680 of FIG. 6. The canceller 700 may subtract an impairment signal from a baseband signal, thereby providing functionality of the first adder 644 or the second adder 654. The canceller 700 may include an impairment signal section 710, a baseband signal section 720, a filter 740. The filter 740 may be an embodiment of the first filter 673 or the second filter 683 of FIG. 6.

The impairment signal section 710 may include a first amplifier 711, a first capacitor 712, a first resistor 713, and a second resistor 714. The first amplifier 711 may receive an analog version of a digital impairment signal (e.g., the analog predicted in-phase impairment signal 647 or the analog predicted quadrature impairment signal 657) through node 715. In some embodiments, the first amplifier 711 may be a variable amplifier that provides a variable amount of gain. The first resistor 713 and the first capacitor 712 may filter the analog version of the digital error signal (e.g., filter noise from the analog version of the digital error signal) in conjunction with the first amplifier 711. Accordingly, an amplified and filtered version of the analog impairment signal is produced at node 716. In some embodiments, the first resistor 713 and the second resistor 714 may control, at least in part, a gain through the impairment signal section 710.

The baseband signal section 720 may include a second amplifier 721, a second capacitor 722, a third resistor 723, and a fourth resistor 724. The second amplifier 721 may receive an analog version of a baseband signal (e.g., first intermediate analog signal 649 or second intermediate analog signal 659) through node 725. In some embodiments, the second amplifier 721 may be a variable amplifier that provides a variable amount of gain. The third resistor 723 and the second capacitor 722 may filter the analog version of the baseband signal (e.g., filter noise from the analog version of the baseband signal) in conjunction with the second amplifier 721. Accordingly, an amplified and filtered version of the analog baseband signal is produced at node 726. In some embodiments, the third resistor 723 and the fourth resistor 724 may control, at least in part, a gain through the baseband signal section 720.

The outputs of the impairment signal section 710 and baseband signal section 720 may be added together and/or combined at node 730 to produce an analog baseband signal. Thus, impairment signals may be summed (e.g., or subtracted) with corresponding baseband signals. In some embodiments, the summing may be controlled by a ratio of the second resistor 714 to the fourth resistor 724.

The filter 740 may include a fifth resistor 741, a sixth resistor 742, a third capacitor 743, and a transistor 744. Node 730 may be coupled to the transistor 744 and the fifth resistor 741. The transistor 744 may provide the analog in-phase signal 321 and/or the analog quadrature signal 322 (signals from node 730) to the amplifier module 330. The transistor 744 may be controlled by control (CNTL) signal. The fifth resistor 741 may be coupled to the sixth resistor 742 and the third capacitor 743. Together the fifth resistor 741, the sixth resistor 742, and the third capacitor 743 may filter the analog baseband signal provide by the node 730 to provide the first filtered baseband signal 674 or the second filtered baseband signal 684. For example, the first filtered baseband signal 674 and/or the second filtered baseband signal 684 may be attenuated by a predetermined amount to enable effective impairment signal detection within the impairment detector 460. In some embodiments, the fifth resistor 741, the sixth resistor 742, and the third capacitor 743 may be optional.

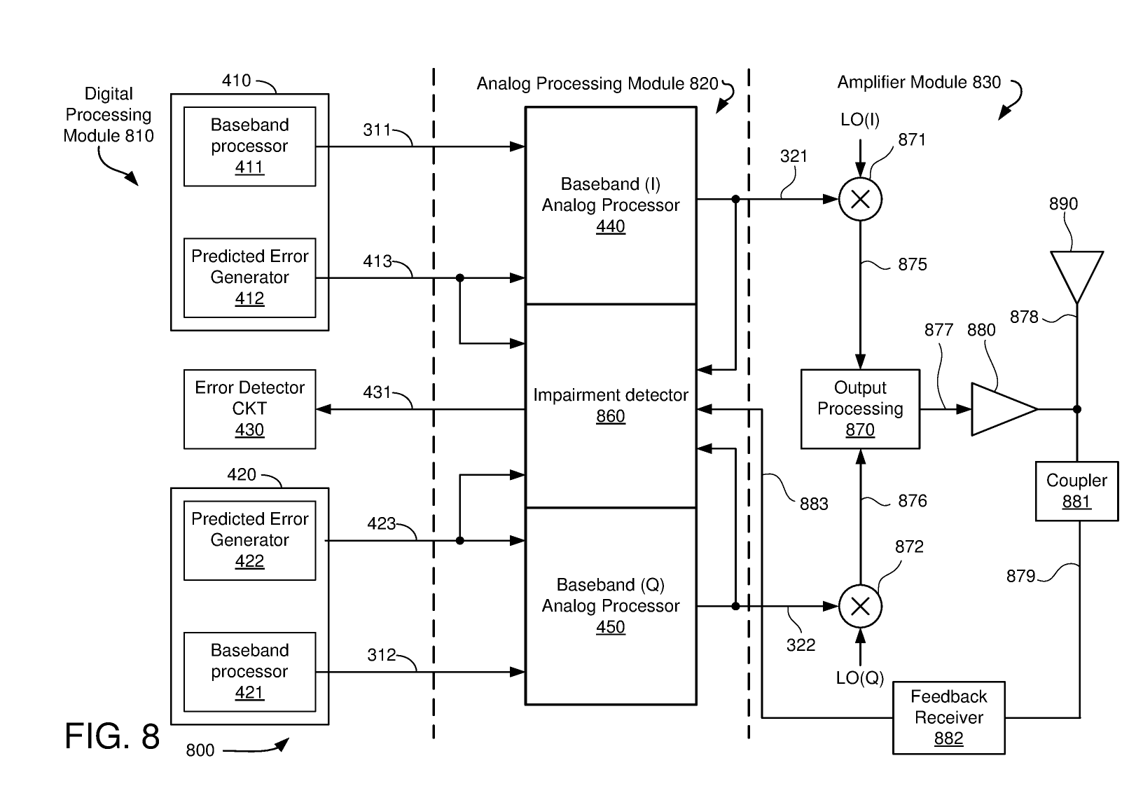

FIG. 8 is a block diagram of a transmitter 800 in accordance with other exemplary embodiments. The transmitter 800 may be another embodiment of the transmitter 300 of FIG. 3. Transmitter 800 may include a digital processing module 810, an analog processing module 820, and an amplifier module 830. In exemplary embodiments, the digital processing module 810 may be similar (if not identical) to digital processing module 310. Thus, the digital processing module 810 may include baseband (I) generator 410, baseband (Q) generator 420, and the error detection circuit 430 as described above with respect to FIG. 4.

The analog processing module 820 may be similar to the analog processing module 320, but may include a different impairment detector. Thus, the analog processing module 820 may include the baseband (I) analog processor 440, the baseband (Q) analog processor 450, and an impairment detector 860. The impairment detector 860 may detect signal impairments in baseband signals (e.g., analog baseband signals 321 and/or 322) and/or modulated signals received from the amplifier module 830.

The amplifier module 830 may amplify and/or modulate the analog baseband signals 321 and 322. For example, the amplifier module 830 may include an output processing unit 870, a first mixer 871, a second mixer 872, a power amplifier 880, a coupler 881, and a feedback receiver 882. The first mixer 871 may mix the analog in-phase signal 321 with an in-phase local oscillator (LO (I)) signal to generate a modulated in-phase signal 875. In a similar manner, the second mixer 872 may mix the analog quadrature signal 322 with a quadrature local oscillator (LO (Q)) signal to generate a modulated quadrature signal 876. The output processing unit 870 may combine the modulated in-phase signal 875 with the modulated quadrature signal 876 to generate a modulated RF signal 877. The power amplifier 880 may amplify the modulated RF signal 877 to produce an amplified RF signal 878. In some embodiments, the power amplifier 880 may include one or more driver amplifiers and/or one or more power amplifiers to provide sufficient gain to transmit the modulated RF signal 877 over a wireless medium. The amplified RF signal 878 may be output by the transmitter 800 via the antenna 890, which may be another embodiment of the primary antenna 210, the secondary antenna 212, or the antenna 340.

In some embodiments, the coupler 881 may also receive the amplified RF signal 878 and may attenuate and/or otherwise reduce a signal power of the amplified RF signal 878 to generate an attenuated RF signal 879. The attenuated RF signal 879 is provided to the feedback receiver 882 and fed back to the impairment detector 860 as a feedback signal 883. In some embodiments, the feedback receiver 882 may demodulate, at least in part, the attenuated RF signal 879 by mixing the attenuated RF signal 879 with LO signals (e.g., LO (I) and LO (Q) signals) to generate the feedback signal 883. Thus, the feedback signal 883 may enable monitoring, attenuating, and/or cancelling of signal impairments that may be introduced after the baseband (I) analog processor 440 or the baseband (Q) analog processor 450. The feedback receiver 882 may include one or more circuits and/or components to generate the feedback signal 883 (not shown for simplicity). For example, the feedback receiver 882 may include one or more transistors, capacitors, resistors, inductors, gates, and/or other components arranged to generate the feedback signal 883.

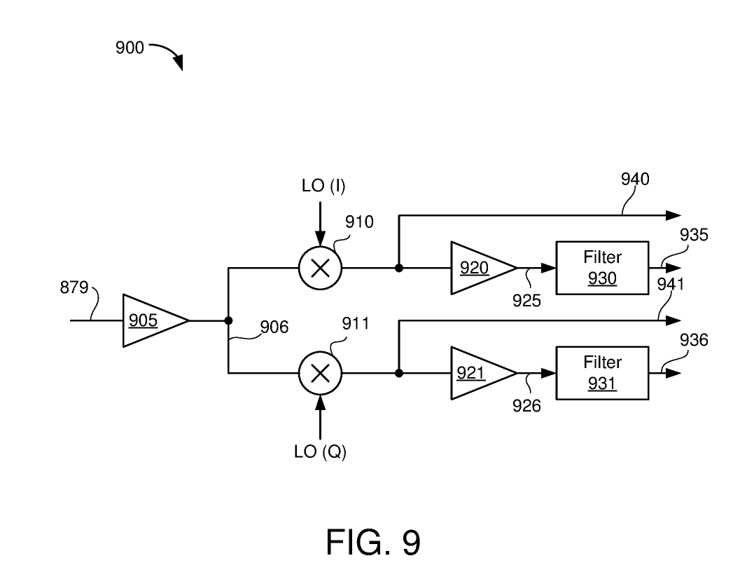

FIG. 9 is a simplified circuit diagram of a feedback receiver 900, in accordance with some exemplary embodiments. Feedback receiver 900 may be an embodiment of the feedback receiver 882 of FIG. 8. The feedback receiver 900 may include a buffer 905, a first mixer 910, a second mixer 911, a first amplifier 920, a second amplifier 921, a first filter 930, and a second filter 931.

Buffer 905 may receive the attenuated RF signal 879 (e.g., from coupler 881) and generate a buffered RF signal 906. The buffered RF signal 906 may be provided to the first mixer 910 and the second mixer 911. The first mixer 910 may mix the buffered RF signal 906 with an in-phase LO signal (e.g., LO (I)) to generate a direct feedback (I) signal 940. In some embodiments, the first mixer 910 may include one or more filters (not shown for simplicity) to select different frequencies for the direct feedback (I) signal 940. Thus, the direct feedback (I) signal 940 may be a demodulated version of the amplified RF signal 878 based on the LO (I) signal (e.g., a demodulated RF signal). The direct feedback (I) signal 940 may be provided to the impairment detector 860 (e.g., as the feedback signal 883 of FIG. 8).

The direct feedback (I) signal 940 is further provided to the first amplifier 920 to generate a buffered feedback signal 925. The first filter 930 may filter the buffered feedback signal 925 to generate a filtered feedback (I) signal 935. In some embodiments the first filter 930 may be a low-pass, high-pass, band-pass, or any other technically feasible filter. In still other embodiments, the first filter 930 may be optional and/or omitted from the feedback receiver 900. In some embodiments, the filtered feedback (I) signal 935 may be provided to error detection circuit 430 and/or included within the feedback signal 883 of FIG. 8.

The second mixer 911 may mix the buffered RF signal 906 with a quadrature LO signal (e.g., LO (Q)) to generate a direct feedback (Q) signal 941. The direct feedback (Q) signal 941 may be provided to the impairment detector 860 (e.g., as the feedback signal 883 of FIG. 8). The direct feedback (Q) signal 941 may further be buffered by the second amplifier 921 to generate a buffered feedback signal 926. The second filter 931 may filter the buffered feedback signal 925 to generate a filtered feedback (Q) signal 936. In some embodiments, the buffered feedback signal 925 may be provided to the error detection circuit 430 and/or included within the feedback signal 883 of FIG. 8.

Thus, the feedback receiver 900 may generate demodulated I and Q signals based on a transmitted RF signal. The demodulated I and Q signals (e.g., the direct feedback signals 940 and 941, respectively) may be used by the error detection circuit 430 to detect signal impairments in the transmitted RF signal.

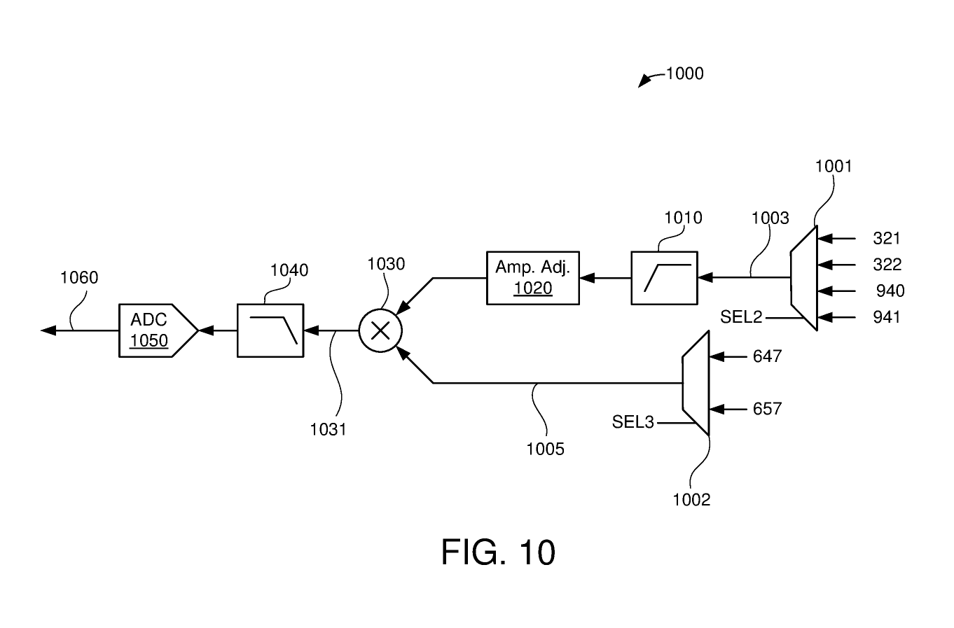

FIG. 10 is a simplified block diagram of an impairment detector 1000, in accordance with some exemplary embodiments. Impairment detector 1000 may be an embodiment of the impairment detector 860 of FIG. 8. The impairment detector 1000 may include a first selector 1001, a second selector 1002, a first filter 1010, an amplitude adjustment module 1020, a mixer 1030, a second filter 1040, and an ADC 1050. Similar to the impairment detector 460 described above with respect to FIG. 4, impairment detector 860 may detect signal impairments in the analog baseband signals 321 and 322. In addition, the impairment detector 1000 may detect signal impairments within a transmitted RF signal using the direct feedback signals 940 and 941. For some embodiments, the impairment detector 1000 may generate an impairment detection signal 1060 that is proportional to the detected amount of signal impairment.

The first selector 1001 may receive the analog in-phase signal 321, the analog quadrature signal 322, the direct feedback (I) signal 940, and the direct feedback (Q) signal 941 as inputs. The first selector 1001 may select one of the first selector 1001 input signals (e.g., the analog in-phase signal 321, the analog quadrature signal 322, the direct feedback (I) signal 940, or the direct feedback (Q) signal 941) for output, as a selected signal 1003, in response to a SEL2 signal. The first filter 1010 filters the selected signal 1003 and provides the filtered signal to the amplitude adjustment module 1020. In some embodiments, the first filter 1010 may be a high-pass filter. The amplitude adjustment module 1020 adjusts an amplitude of the selected signal 1003, as received from the first filter 1010, and passes the selected signal 1003 to the mixer 1030.

The second selector 1002 may select either the analog predicted in-phase impairment signal 647 or the analog predicted quadrature impairment signal 657, as a selected analog predicted impairment signal 1005, in response to a SEL3 signal. The selected analog predicted impairment signal 1005 is provided to the mixer 1030, which may mix the selected signal 1003 with the selected analog predicted impairment signal 1005 to generate a mixer output signal 1031. The mixer output signal 1031 may be filtered by second filter 1040 and converted to an impairment detection signal 1060 by ADC 1050. In some embodiments, the second filter 1040 may be a low-pass filter.

For some embodiments, the impairment detection signal 1060 may indicate a magnitude of the selected analog predicted impairment signal 1005 (e.g., output by the second selector 1002) as it relates to the selected signal 1003 (e.g., output by first selector 1001). Thus, the impairment detection signal 1060 may indicate the magnitude of an impairment signal included within a corresponding baseband and/or modulated baseband signal.

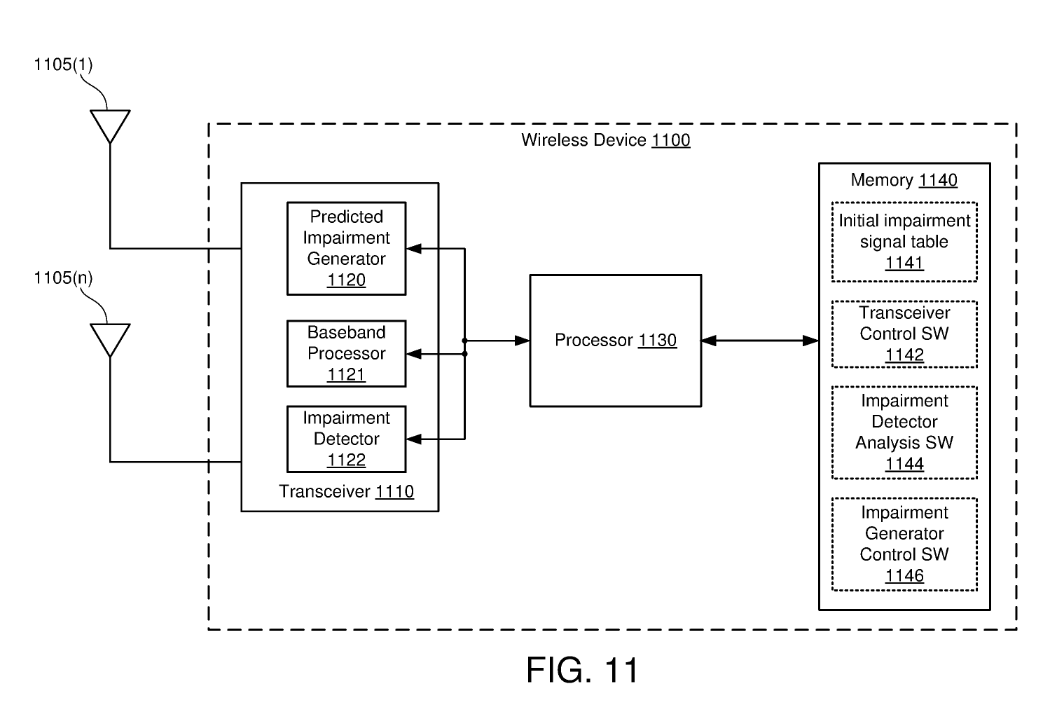

FIG. 11 shows a wireless device 1100 which may be one embodiment of the wireless device 110 of FIG. 1. Wireless device 1100 includes a number of antennas 1105(1)-1105(n), a transceiver 1110, a processor 1130, and a memory 1140. The transceiver 1110 may be coupled to antennas 1105(1)-1105(n) directly or through one or more antenna interface circuits 224, 226 (not shown for simplicity). Transceiver 1110 may receive and transmit communication signals and communicate with other wireless devices through one or more communication channels. In some embodiments, transceiver 1110 may include some or all of the elements in transmitter 250pa-250pk, transmitter 250sa-250sl, or transmitter 300. In a similar manner, transceiver 1110 may include some or all elements in receiver 230pa-230pk or receiver 230sa-230sl. Transceiver 1110 may include any number of transmit processing paths to process and transmit signals to other wireless devices via antennas 1105(1)-1105(n), and may include any number of receive processing paths to process signals received from antennas 1105(1)-1105(n). Thus, for example embodiments, the wireless device 1100 may be configured for multiple-input, multiple-output (MIMO) operations. The MIMO operations may include single-user MIMO (SU-MIMO) operations and multi-user MIMO (MU-MIMO) operations.

Transceiver 1110 may include a predicted impairment generator 1120, a baseband processor 1121, and an impairment detector 1122. The predicted impairment generator 1120 may generate one or more predicted impairment signals to cancel and/or attenuate impairment signals that may be included with a baseband and/or a modulated communication signal. Predicted impairment generator 1120 may be an embodiment of first predicted impairment generator 412, second predicted impairment generator 422, or predicted impairment generator 520.

Baseband processor 1121 may generate baseband signals and/or modulated RF signals to be transmitted via antennas 1105(1)-1105(n). The baseband processor 1121 may be an embodiment of the first baseband processor 411, the baseband (I) analog processor 440, the second baseband processor 421, or the baseband (Q) analog processor 450.

Impairment detector 1122 may detect one or more impairment signals included with a baseband signal or a modulated RF signal. In some embodiments, the impairment detector 1122 may generate an impairment detection signal (e.g., impairment detection signal 431) to indicate the detected amount of signal impairment. Impairment detector 1122 may be an embodiment of impairment detector 460, impairment detector 860, or impairment detector 1000.

Memory 1140 may include an initial impairment signal data table 1141 for storing data that may be used (e.g., by the predicted impairment generator 1120) to generate different impairment signals. For example, the initial impairment signal data table 1141 may include data to generate a 4FMOD signal, a RSB signal, and/or an intermodulation distortion signal.

Further, memory 1140 may also include a non-transitory computer-readable storage medium (e.g., one or more nonvolatile memory elements, such as EPROM, EEPROM, Flash memory, a hard drive, etc.) that may store the following software modules:
a transceiver control software module 1142 to control the transceiver 1110 to generate one or more baseband signals (e.g., via baseband processor 1121);
an impairment detector analysis software module 1144 to analyze an impairment detection signal from the impairment detector 1122; and
an impairment generator control software module 1146 to control the predicted impairment generator 1120 to modify a predicted impairment signal.
   Each software module includes program instructions that, when executed by processor 1130, may cause the wireless device 1100 to perform the corresponding function(s). Thus, the non-transitory computer-readable storage medium of memory 1140 may include instructions for performing all or a portion of the operations of FIG. 12.

Processor 1130, which is coupled to transceiver 1110, and memory 1140, may be any of one or more suitable processors capable of executing scripts or instructions of one or more software programs stored in the wireless device 1100 (e.g., within memory 1140).

Processor 1130 may execute the transceiver control software module 1142 to transmit and/or receive communication signals through transceiver 1110. For example, the transceiver control software module 1142, as executed by the processor 1130, may control the transceiver 1110 to generate one or more baseband signals (e.g., via baseband processor 1121). In some embodiments, the processor 1130, in executing the transceiver control software module 1142, may further control the transceiver 1110 to modulate the one or more baseband signals onto a carrier signal.

Processor 1130 may execute the impairment detector analysis software module 1144 to monitor impairment detection signals from the impairment detector 1122. Upon receiving an impairment detection signal, the impairment detector analysis software module 1144, as executed by the processor 1130, may modify a phase or amplitude of a corresponding predicted impairment signal and/or the baseband signal to attenuate the impairment signal included with the baseband and/or modulated RF signal.

Processor 1130 may execute the impairment generator control software module 1146 to modify the predicted impairment signal. For example, the impairment generator control software module 1146, as executed by the processor 1130, may modify a phase and/or gain of the predicted impairment signal (e.g., in a manner indicated by the impairment detector analysis software module 1144).

FIG. 12 shows an illustrative flow chart depicting an example operation 1200 for generating a predicted impairment signal in accordance with example embodiments. With reference, for example, to FIGS. 3, 4, 6, and 8, the operation 1200 may be performed by a transmitter 300 of a wireless device.

The transmitter 300 may first generate an initial impairment signal (1202). For example, the initial impairment signal may be generated by the first predicted impairment generator 412, the second predicted impairment generator 422, or the predicted impairment generator 520. Initial impairment signal may be an estimate of an impairment signal predicted to be included with a baseband signal and/or a modulated RF signal. For example, the initial impairment signal may be a predicted 4FMOD signal (e.g., a third and/or fifth harmonic of a modulating signal), a predicted RSB signal, or a predicted intermodulation distortion signal.

Next, the transmitter 300 may subtract the predicted impairment signal from a baseband signal (1204). In some embodiments, the subtraction operation may be performed by the first canceller 670, the second canceller 680, or the canceller 700. The baseband signal may be provided by the first baseband processor 411 or the second baseband processor 421. Next, the transmitter 300 may generate an impairment detection signal (1206). The impairment detection signal may indicate a presence of signal impairments in the baseband and/or the feedback signal and/or may be proportional to a magnitude of an impairment signal included with the corresponding baseband and/or feedback signal. The feedback signal may be a demodulated RF transmit signal. In some embodiments, the impairment detection signal may be generated by the impairment detector 460, impairment detector 860, or impairment detector 1000.

The transmitter 300 may adjust a phase of the predicted impairment signal (1208). In some embodiments, the phase of the predicted impairment signal is adjusted until the impairment detection signal (as detected by error detection circuit 430) reaches a relative maximum level. For example, when the impairment detection signal is a relative maximum, the phase of the predicted impairment signal may be adjusted to effectively cancel or attenuate the detected impairment signal. In some embodiments, the phase of the predicted impairment signal may be adjusted by the impairment phase adjustment module 523.

The transmitter 300 may further adjust an amplitude of the predicted impairment signal (1210). In some embodiments, the amplitude of the predicted impairment signal is adjusted until the impairment detection signal reaches a relative minimum level. For example, when the impairment detection signal is a relative minimum (as detected by error detection circuit 430), the amplitude of the predicted impairment signal may be adjusted to effectively cancel or attenuate the detected impairment signal. In some embodiments, the amplitude of the predicted impairment signal may be adjusted by the impairment amplitude adjustment module 522, the first analog amplitude adjustment module 645, the second analog amplitude adjustment module 655, and/or the canceller 700 (e.g., the first amplifier 711). Further, for some embodiments, the phase of the predicted impairment signal may be inverted (e.g., 180 degree phase shift) prior to adjusting the amplitude of the predicted impairment signal.

The transmitter 300 may determine whether another predicted impairment signal is to be generated (1212). For example, the transmitter 300 may include multiple predicted impairment generators (e.g., similar to the first predicted impairment generator 412 and/or second predicted impairment generator 422). Accordingly, the operation 1200 may be repeated for any number of predicted impairment generators. If no additional predicted impairment signals are to be generated, then operations end.

As described above, the predicted impairment signal may be a 4FMOD signal, a RSB signal, an intermodulation distortion signal, or any other technically feasible signal to be detected by the transmitter 300. For example, a DC offset or an I/O mismatch impairment signal may also be generated to detect and correct DC offset and/or I/O mismatch, respectively. In some embodiments, the operation 1200 may be repeated (e.g., performed twice) for I/O signal pairs. Further, in some embodiments, multiple instances of the operation 1200 may be interleaved to allow impairment detector 460 or 860 to be shared by I and Q data processing paths.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media.

In the foregoing specification, the exemplary embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A wireless device comprising:
a first circuit to generate a baseband signal;
a second circuit to generate a first impairment signal associated with the baseband signal; and
a detector circuit to generate an impairment detection signal based, at least in part, on the first impairment signal and a first signal formed by combining the first impairment signal and the baseband signal.

2. The wireless device claim 1, wherein the detector circuit comprises:
a mixer to multiply the first impairment signal and the baseband signal to generate the impairment detection signal.

3. The wireless device of claim 1, wherein a magnitude of the impairment detection signal is proportional to a magnitude of the first impairment signal within the baseband signal.

4. The wireless device of claim 1, further comprising:
a filter to reject frequencies in the baseband signal that are below a threshold frequency.

5. The wireless device of claim 1, wherein the second circuit is to generate the first impairment signal based, at least in part, on the impairment detection signal.

6. The wireless device of claim 1, wherein the detector circuit is to generate the impairment detection signal based, at least in part, on an impairment signal within a demodulated radio frequency (RF) signal.

7. The wireless device of claim 6, further comprising:
a feedback circuit to generate the demodulated RF signal based, at least in part, on a modulated RF signal to be transmitted by the wireless device.

8. The wireless device of claim 1, further comprising:
a third circuit to generate a second impairment signal, wherein the first impairment signal is an in-phase impairment signal and the second impairment signal is a quadrature impairment signal.

9. The wireless device of claim 1, further comprising:
a canceller to subtract the first impairment signal from the baseband signal to generate the first signal.

10. The wireless device of claim 9, wherein the canceller is configured to filter noise from the first impairment signal.

11. A method of transmitting a wireless communication signal by a wireless device, the method comprising:
generating, by a baseband processor circuit, a baseband signal;
generating, by a first impairment generator, a first impairment signal associated with the baseband signal; and
generating an impairment detection signal based, at least in part, on the first impairment signal and a first signal formed by combining the first impairment signal and the baseband signal.

12. The method of claim 11, further comprising:
multiplying the first impairment signal and the baseband signal to generate the impairment detection signal.

13. The method of claim 12, wherein a magnitude of the impairment detection signal is proportional to a magnitude of the first impairment signal within the baseband signal.

14. The method of claim 11, wherein the first impairment signal is based, at least in part, the impairment detection signal.

15. The method of claim 11, wherein the impairment detection signal is based, at least in part, on an impairment signal included within modulated radio frequency (RF) signal.

16. The method of claim 11, further comprising:
generating, by a second impairment generator, a second impairment signal, wherein the first impairment signal is an in-phase impairment signal and the second impairment signal is a quadrature impairment signal.

17. The method of claim 11, further comprising:
subtracting the first impairment signal from the baseband signal to generate the first signal.

18. A non-transitory computer-readable medium storing instructions that, when executed by one or more processors of a wireless device, cause the wireless device to:
generate, by a baseband processor circuit, a baseband signal;
generate, by a first impairment generator, a first impairment signal associated with the baseband signal; and
generate an impairment detection signal based, at least in part, on the first impairment signal and a first signal formed by combining the first impairment signal and the baseband signal.

19. The non-transitory computer-readable medium of claim 18, further comprising instructions to cause the wireless device to:
multiply the first impairment signal and the baseband signal to generate the impairment detection signal.

20. The non-transitory computer-readable medium of claim 18, wherein a magnitude of the impairment detection signal is proportional to a magnitude of the first impairment signal within the baseband signal.

21. The non-transitory computer-readable medium of claim 18, wherein the first impairment signal is based, at least in part, the impairment detection signal.

22. The non-transitory computer-readable medium of claim 18, further comprising instructions to cause the wireless device to:
generate, by a second impairment generator, a second impairment signal, wherein the first impairment signal is an in-phase impairment signal and the second impairment signal is a quadrature impairment signal.

23. The non-transitory computer-readable medium of claim 18, further comprising instructions to cause the wireless device to:
subtract the first impairment signal from the baseband signal to generate the first signal.

24. An impairment detector comprising:
a first selector to receive a first modified baseband signal;
a second selector to receive a first impairment signal; and
a mixer to generate a detection signal based, at least in part, on the first impairment signal and the first modified baseband signal.

25. The impairment detector of claim 24, wherein the first modified baseband signal is generated by combining the first impairment signal and an unmodified baseband signal.

26. The impairment detector of claim 25, wherein the first impairment signal is subtracted from the unmodified baseband signal.

27. The impairment detector of claim 24, wherein the mixer is configured to multiply together the first modified baseband signal and the first impairment signal.

28. The impairment detector of claim 24, wherein the detection signal is based, at least in part, on a magnitude of the first impairment signal within the first modified baseband signal.

29. The impairment detector of claim 24, wherein the first selector is configured to select at least one of the first modified baseband signal and a second modified baseband signal or a combination thereof, and wherein the first modified baseband signal is an in-phase baseband signal, and the second modified baseband signal is a quadrature baseband signal.

30. The impairment detector of claim 24, wherein the second selector is configured to select at least one of the first impairment signal and a second impairment signal or a combination thereof, and wherein the first impairment signal is an in-phase impairment signal, and the second impairment signal is a quadrature impairment signal.
